(19) United States
(12) Patent Application Publication
(10) Pub. No.: US 2007/0280225 A1
(43) Pub. Date: Dec. 6, 2007

(54) Extended services and recommendations

(75) Inventors: Scott C. Forbes, Redmond, WA (US); David Milstein, Redmond, WA (US); Kuansan Wang, Bellevue, WA (US); Linda Criddle, Kirkland, WA (US); Lon-Chan Chu, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/444,799

(22) Filed: May 31, 2006

(51) Int. Cl. H04L 12/56

(52) U.S. Cl. 370/389; 370/401; 370/352

(57) ABSTRACT

Generally described, the present invention relates to the identification, extraction, and further use of content contained in a digital voice conversation, such as a Voice over Internet Protocol (VoIP) conversation. More specifically, the present invention relates to the use of “mined” data from a conversation to provide extended services, such as recommendations to individuals participating in a digital voice conversation.

### BACKGROUND

Generally described, an Internet telephony system provides an opportunity for users to have a call connection with enhanced calling features compared to a conventional telephony system. In a typical Internet telephony system, often referred to as Voice over Internet Protocol (VoIP), audio information is processed into a sequence of data blocks, called packets, for conversations utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of conversations, ability to establish and control multimedia communication, and the like. VoIP technology will likely continue to gain favor because of its ability to provide enhanced calling features and advanced services.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect, a method for providing extended services to a client is provided. The method includes obtaining one or more mined digital conversation data packets and determining if the obtained data packets contain relevant content. If it is determined that the obtained digital conversation data packets contain relevant content, additional information is obtained related to the content and provided to the client. For example, a recommendation related to the substance of the relevant content may be generated and provided to the client.

In accordance with another aspect, a computer-readable medium having computer-executable components for providing extended services to a client is provided. The computer-readable medium includes a monitoring component configured to monitor a digital voice conversation and identify data packets that contain relevant content. A processing component may also be included that is configured to obtain additional information related to the relevant content and provide the obtained additional information to a client.

In accordance with still another aspect, a method for specifying information that is to be used for providing recommendation services is provided. The method includes maintaining a mining profile for a client. The mining profile may include types of content that is to be identified from a conversation and mined. The mining profile may also identify what conversations (e.g., conversations with which clients) are to be mined using the mining profile.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of various VoIP devices corresponding to a VoIP client in accordance with an aspect of the present invention;

FIG. 3 is a block diagram illustrative of various components associated with a VoIP client device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a conversation channel established in the VoIP environment of FIG. 1;

FIG. 6 is a block diagram illustrating interactions between two VoIP clients for transferring contextual information defined by identified structured hierarchies in accordance with an aspect of the present invention;

FIG. 7A is a block diagram illustrating interactions between two VoIP clients for exchanging mining profiles in accordance with an embodiment of the present invention;

FIG. 7B is a block diagram illustrating interactions between VoIP clients and a recommendation service for providing recommendations in accordance with an embodiment of the present invention;

FIGS. 8-12 are block diagrams illustrative of various attributes and classes of structured hierarchies corresponding to VoIP contextual information in accordance with an aspect of the present invention;

FIG. 13 is a flow diagram of a mining routine for mining a digital voice conversation in accordance with an aspect of the present invention;

FIG. 14 is a flow diagram of a mined data routine for processing data packets that have been mined according to an embodiment of the present invention; and

FIG. 15 is a flow diagram of an extended services routine for providing additional information in accordance with an embodiment of the present invention.

### DETAILED DESCRIPTION

Generally described, the present invention relates to the identification, extraction, and further use of content contained in a digital voice conversation, such as a Voice over Internet Protocol (VoIP) conversation. More specifically, the present invention relates to the use of “mined” data from a conversation to provide extended services, such as recommendations. “Mining” or “mining services” as used herein is the processing of a conversation to identify data (conversation and/or contextual) of interest. Mining may be performed during a conversation on data as it is being exchanged. Alternatively, mining may be performed on historical, or stored data (such data may relate to events or actions that have happened in the past, are currently happening, or will happen in the future). The identified data, referred to herein as “mined data,” may be used by other services or applications (such as a recommendation service), stored, forwarded, extracted from the conversation, replaced, supplemented with additional data, etc. Similar to mining, processing of mined data may be done real-time during a conversation. Alternatively, or in addition thereto, mined data may be stored and post-processed.

One technique for assisting in the mining of data is through the utilization of classes and attributes defined by “structured hierarchies” for representing contextual information over a conversation channel in an Internet Protocol (IP) network environment. “Structured hierarchies,” as used herein, are predefined organizational structures for arranging contextual information to be exchanged between two or more VoIP devices. For example, structured hierarchies can be defined by hierarchical organizations of various classes and attributes, such as XML namespaces.

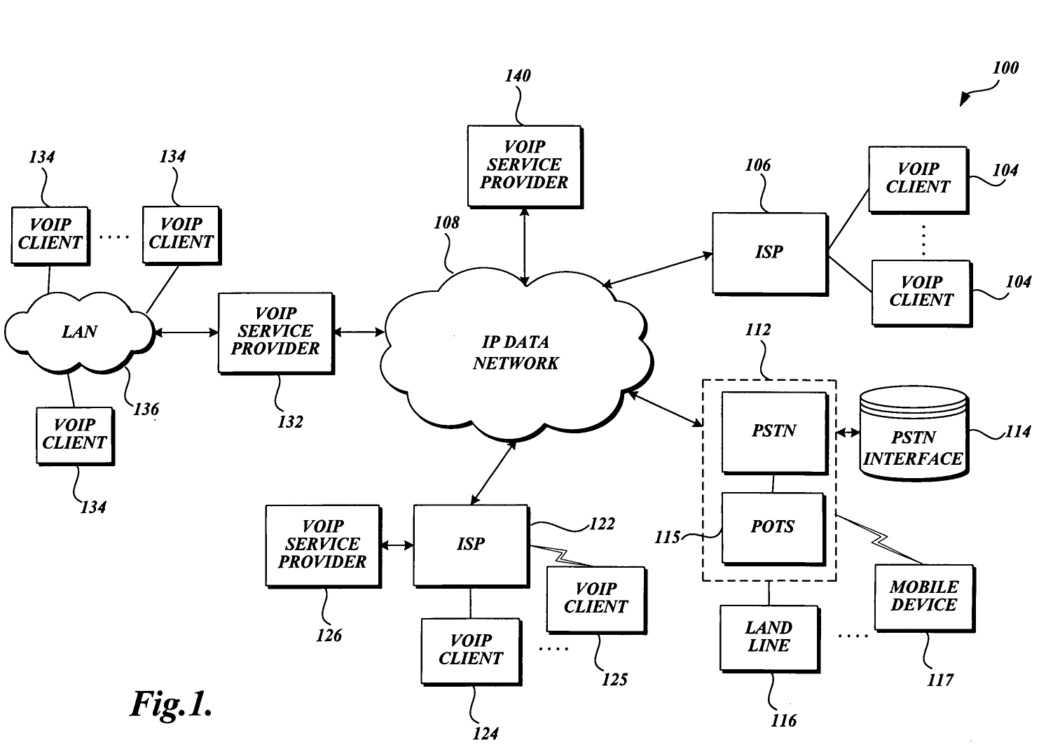

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices, and a unique VoIP client identifier. For example, a single individual, five associated VoIP devices, and a unique VoIP client identifier collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108, such as the Internet, a wide area network (“WAN”), a local area network (“LAN”), and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, data may be mined from a conversation by a client, client device, service provider, a third party service (e.g., extended service or recommendation service), or any combination thereof. In one embodiment, one or more “mining profiles” may be defined for each client in a conversation and/or for third parties (e.g., service providers). A “mining profile” specifies types of data/content that is of interest to a client and/or a third party and what is to be done with that data/content once identified. For example, a client may create a mining profile that indicates that they are interested in shoes. That voice profile may be used to process a conversation and mine data packets that include discussions about shoes. The mined data packets may then be further processed to determine that the conversation is/was about Nike® shoes, and additional information regarding Nike® shoes (e.g., sales of Nike® shoes) may be obtained and provided. For example, a recommendation service may use the mined data to identify Nike® shoe sales, and recommend that the individuals participating in the conversation visit one of the sales. Additionally, as described below, a user may provide additional information to the recommendation service to receive more detailed/focused recommendations. For example, if the user has provided their shoe size, the recommendation service may identify a sale on Nike® shoes, contact the selling party to confirm it has the appropriate shoe size, and optionally place a hold on the shoe. The recommendation service may recommend to the individual the specific shoe that is for sale, and optionally provide the ability to buy the shoe through interaction with the recommendation service.

The IP telephony environment 100 may also include third party VoIP service providers 140. The VoIP service providers 126, 132, 140 may provide various calling features, such as incoming call-filtering, text data, voice and media data integration, mining services, and integrated data transmission as part of a VoIP call conversation. The VoIP service providers 126, 132, 140 may also generate, maintain, and provide mining profiles for clients communicating in a call conversation to assist in identifying data to be mined. As an alternative, or in addition thereto, VoIP clients 104, 124, 125, 136 may create, maintain, and provide mining profiles.

VoIP service providers 132 may be coupled to a private network, such as a company LAN 136, providing IP telephone services (e.g., internal calls within the private network, external calls outside of the private network, and the like), and multimedia data services to several VoIP clients 134 communicatively connected to the company LAN 136. Similarly, VoIP service providers, such as VoIP service provider 126, may be coupled to Internet service provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 communicatively connected to a Public Switch Telephone Network (PSTN) 112. A PSTN interface 114, such as a PSTN gateway, may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional devices, such as land line 116, may request a connection with the VoIP client based on the unique VoIP identifier of that client, and the appropriate VoIP device associated with the VoIP client will be used to establish a connection. In one example, an individual associated with the VoIP client may specify which device is to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any number and combination of suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

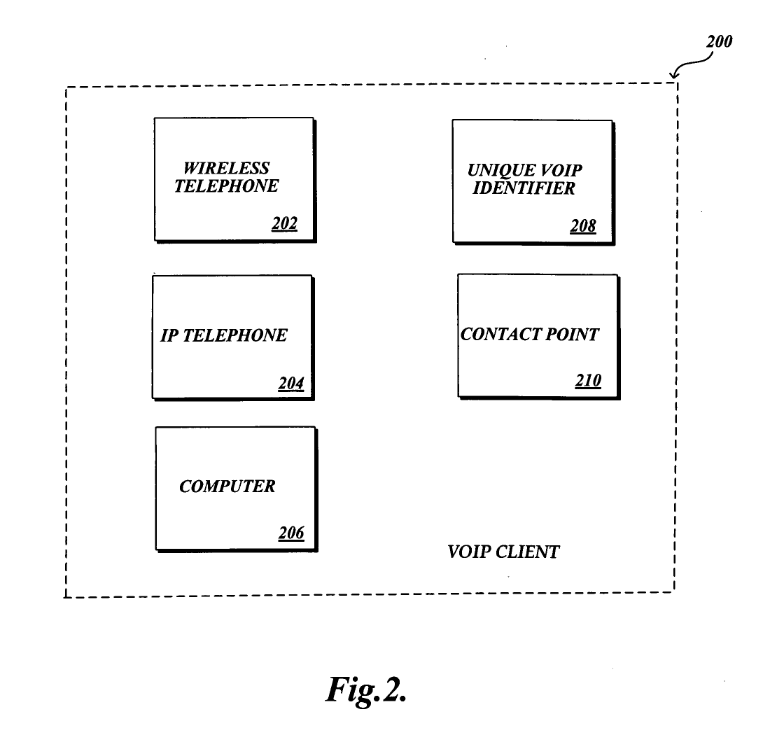

Referring now to FIG. 2, a block diagram illustrating an exemplary VoIP client 200 that includes several VoIP devices and a unique VoIP identifier in accordance with an embodiment of the present invention is shown. Each VoIP device 202, 204, 206 may include a storage that is used to maintain voice messages, address books, client specified rules, voice profiles, mining profiles, etc. Alternatively, or in addition thereto, a separate storage, maintained, for example, by a service provider, may be associated with the VoIP client and accessible by each VoIP device that contains information relating to the VoIP client. In an embodiment, any suitable VoIP device, such as a wireless phone 202, an IP phone 204, or a computer 206 with proper VoIP applications, may be part of the VoIP client 200. The VoIP client 200 also maintains one or more unique VoIP identifier(s) 208. The unique VoIP identifier(s) 208 may be constant or change over time. For example, the unique identifier(s) 208 may change with each call. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In alternative embodiments, the VoIP client 200 may maintain multiple VoIP identifiers. In this embodiment, a unique VoIP identifier may be temporarily assigned to the VoIP client 200 for each call session.

The unique VoIP identifier may be used similar to a telephone number in PSTN. However, instead of dialing a typical telephone number to ring a specific PSTN device, such as a home phone, the unique VoIP identifier is used to reach a contact point, such as an individual or company that is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS device using a personal computer (VoIP device), the VoIP client identification number in conjunction with an IP address of the personal computer will eventually be converted into a telephone number recognizable in PSTN.

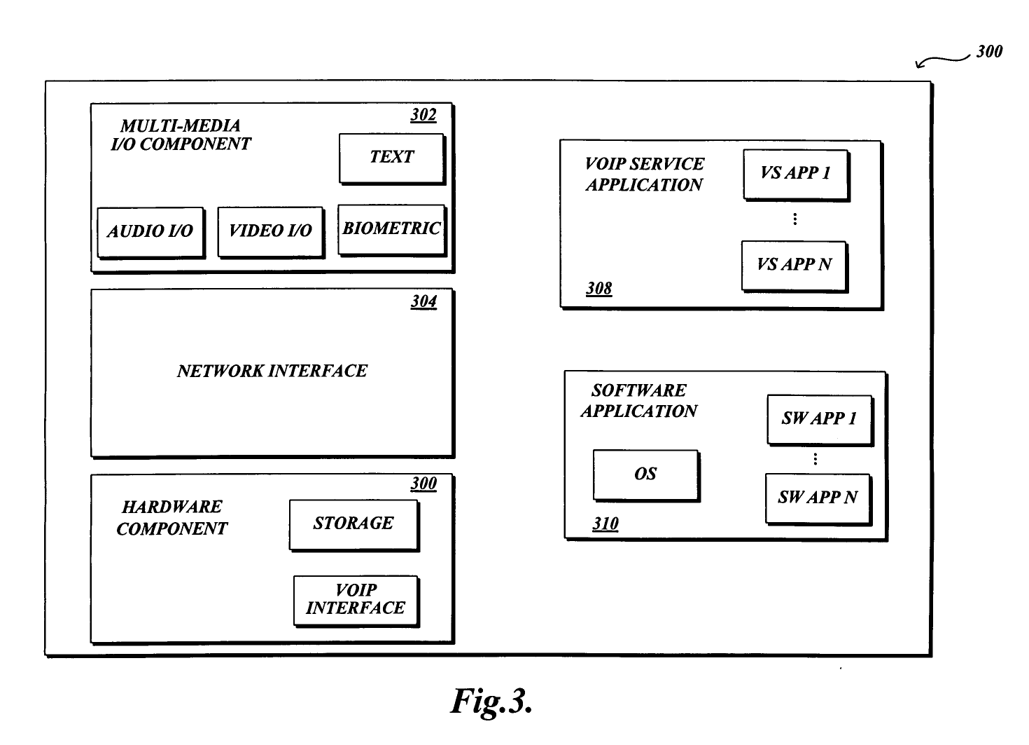

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting, and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components, such as a microphone, a video camera, a display screen, a keyboard, user biometric recognition devices, and the like. The multimedia input/output component 302 may also receive and transmit multimedia data via the network interface component 304. The network interface component 304 may support interfaces, such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage, such as read-only memory devices (ROM), random access memory (RAM), hard drives, optical drives, and the like. The storage may be configured to store program instructions for controlling the operation of an operating system and/or one or more applications and to store contextual information related to individuals (e.g., mining profiles) associated with the VoIP client in which the device is included. In one embodiment, the hardware component 306 may include a VoIP interface card which allows non-VoIP client devices to transmit and receive a VoIP conversation.

The device 300 may further include a software application component 310 for the operation of the device 300 and a VoIP service application component 308 for supporting various VoIP services. The VoIP service application component 308 may include applications, such as data packet assembler/disassembler applications, a structured hierarchy parsing application, audio Coder/Decoder (CODEC), video CODEC, and other suitable applications for providing VoIP services. The software application component 300 may also include a mining component that utilizes one or more mining profiles to mine data from a conversation. A client may maintain and use more than one mining profile. For example, different mining profiles, identifying different types of content to be mined, may be established for personal, business, family, friends, etc., and may be selected and used based on the conversation. The mining component may utilize technologies, such as, but not limited to, speech recognition, keyword searching, image recognition, voice recognition, contextual data searching, and/or packet analysis, to mine data from a conversation.

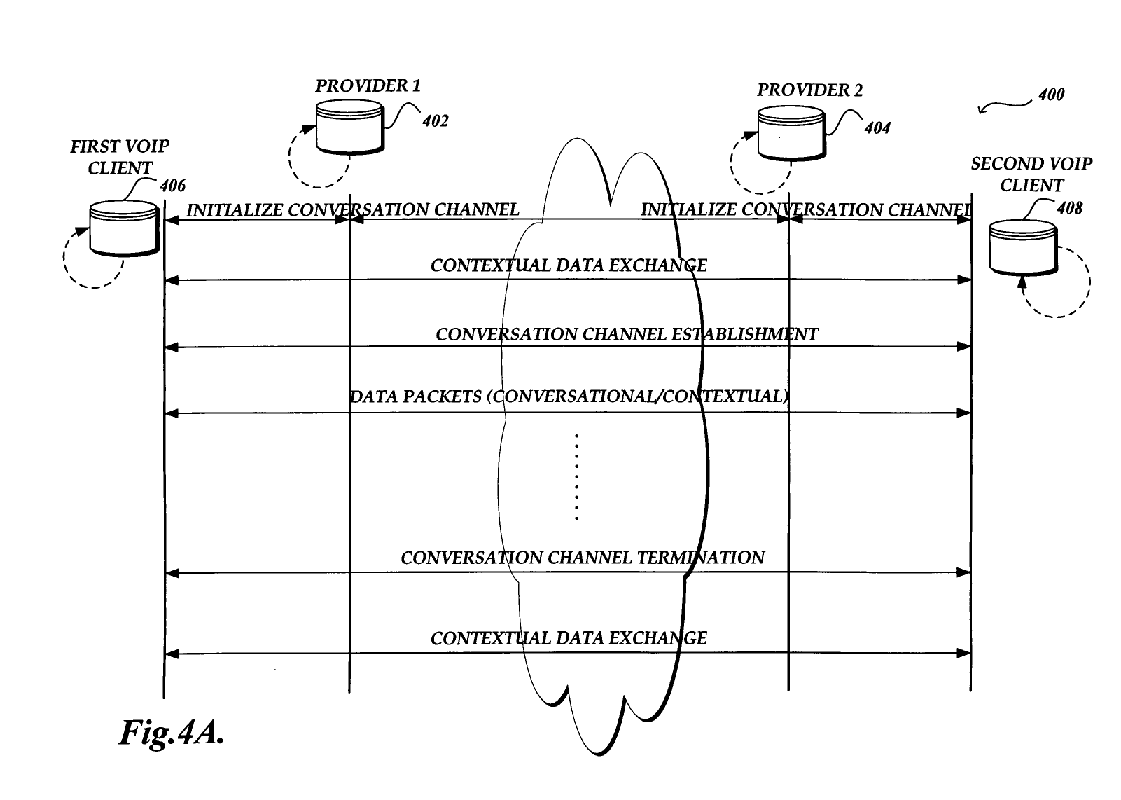

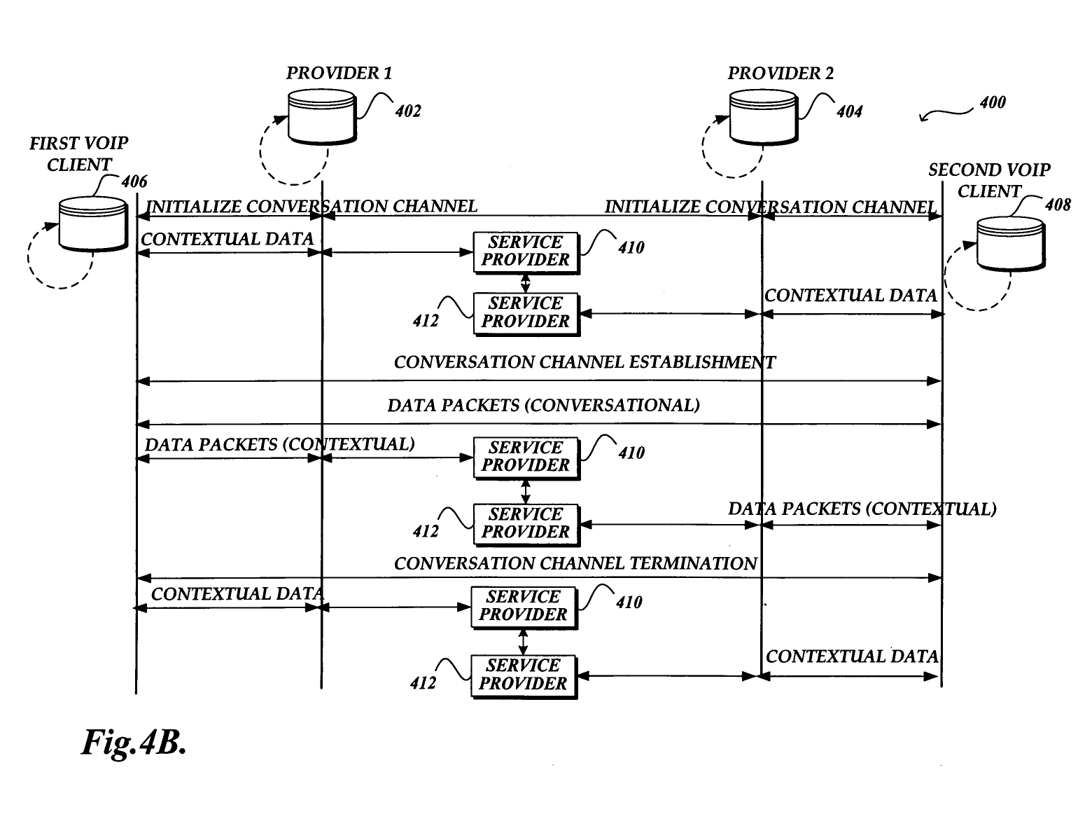

With reference to FIG. 4A, a block diagram illustrative of a conversation flow 400 between VoIP devices of two different VoIP clients over a conversation channel in accordance with an embodiment of the present invention is shown. While the example provided herein focuses on communication between two VoIP clients, it will be appreciated that conversations may be between any number of VoIP clients. During a connection set-up phase, a VoIP device of a first VoIP client 406 requests to initiate a conversation channel with a second VoIP client 408. In an illustrative embodiment, a VoIP service provider 402 (Provider1) for the first VoIP client 406 receives the request to initiate a conversation channel and forwards the request to a VoIP service provider 404 (Provider2) for the second VoIP client 406.

While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer-to-peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only include one VoIP device. Accordingly, the discussion provided herein will refer to connection of the two VoIP devices. The individual using the device of the first VoIP client 406 may select or enter the unique VoIP identifier of the client that is to be called. If mining is to be done by the device of the first client, an appropriate mining profile may be selected. The mining profile may be manually selected by the individual. Alternatively, the mining profile may be automatically selected based on, for example, the device being used, the client being called, the location from which the call is being made, the time of day, etc.

Provider 1 402 receives the request from the device of the first VoIP client 408 and determines a terminating service provider (e.g., Provider 2 404 of the second VoIP client 408) based on the unique VoIP identifier included in the request. Additionally, if Provider 1 402 is to mine data, the appropriate mining profile(s) is selected using any of the techniques discussed above. The request is then forwarded to Provider 2 404. This call initiation will be forwarded to the device of the second VoIP client. A conversation channel between the device of the first VoIP client 406 and a device of the second VoIP client 408 can then be established. If either, or both, Provider 2 404, or the second VoIP client are to mine data, the appropriate mining profile(s) for the second client may be identified for the conversation.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, the VoIP client 408 being called, and optionally, third-party services.

Available media types, rules of the calling client and the client being called, appropriate mining profiles of the calling client and the client being called, and the like may also be part of the contextual information that is exchanged during the connection set-up phase. The contextual information may be processed and collected by one of the devices of the first VoIP client 406, one of the devices of the second VoIP client 408, and/or by VoIP service providers (e.g., Provider 1 402 and Provider 2 404) depending on the nature of the contextual information. In one embodiment, the VoIP service providers 402, 404 may add and/or delete some information to/from the client's contextual information before forwarding the contextual information.

In response to a request to initiate a conversation channel, the second VoIP client 408 may accept the request for establishing a conversation channel or execute other appropriate actions, such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices. Some or all of the exchanged data packets may be mined for data matching requirements of the mining profiles.

Conversation data packets carry data related to a conversation, for example, a voice data packet or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider1) for the first VoIP client 406 receives the request to initiate a conversation channel and forwards the request to a VoIP service provider 404 (Provider2) for the second VoIP client 408. As with the example described above with respect to FIG. 4A, any one or more of the first VoIP client 406, Provider 1 402, Provider 2 404, and/or the second VoIP client 408 may be specified to mine data from the conversation. As such, the device(s) may identify, and optionally exchange, appropriate mining profiles for the conversation with other devices.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, and/or the VoIP service providers (e.g., Provider1 and Provider2) depending on the nature of the contextual information. For example, mining profiles may be selected and received by the service providers 402, 404 and only temporarily provided to the devices. Further, third party service provider(s) 410, 412 may also maintain mining profiles for use in mining data from the conversation. For example, the first VoIP client may have requested that a third party provider mine all conversations for particular content. Similarly, the service provider 410, 412 may be a company from which the first VoIP client is calling or a company in which the second VoIP client 408 is located. The companies may have mandatory mining profiles that are used to mine conversations for particular keywords that relate to trade secret information of that company. Upon identification of a conversation that includes those keywords, the mined data may be stored for later use and other processing may be performed (e.g., terminating the conversation, requiring further authentication/permission settings before continuing, etc.). In one embodiment, any of Provider 1 402, Provider 2 404, and third party service provider 410, 412 may add, modify, and/or delete contextual information before forwarding the contextual information to the next VoIP device(s), including other service providers.

In response to a request to initiate a conversation channel, the second VoIP client 408 may accept the request for establishing a conversation channel or reject the request via Provider 2 404. When a conversation channel has been established, the devices of the first VoIP client 406 and the second VoIP client 408 start communicating with each other by exchanging data packets as discussed above. In one embodiment, contextual and/or conversation data packets may be forwarded to third party service providers 410, 412 from Provider 1 402, Provider 2 404, or from either VoIP client 406, 408. Further, the forwarded contextual and/or conversation data packets may be exchanged among various third party service providers 410, 412. Any of the VoIP clients 406, 408, service providers 402, 404, or the third party service providers 410, 412 may mine the contextual and/or conversation data packets based on selected mining profiles.

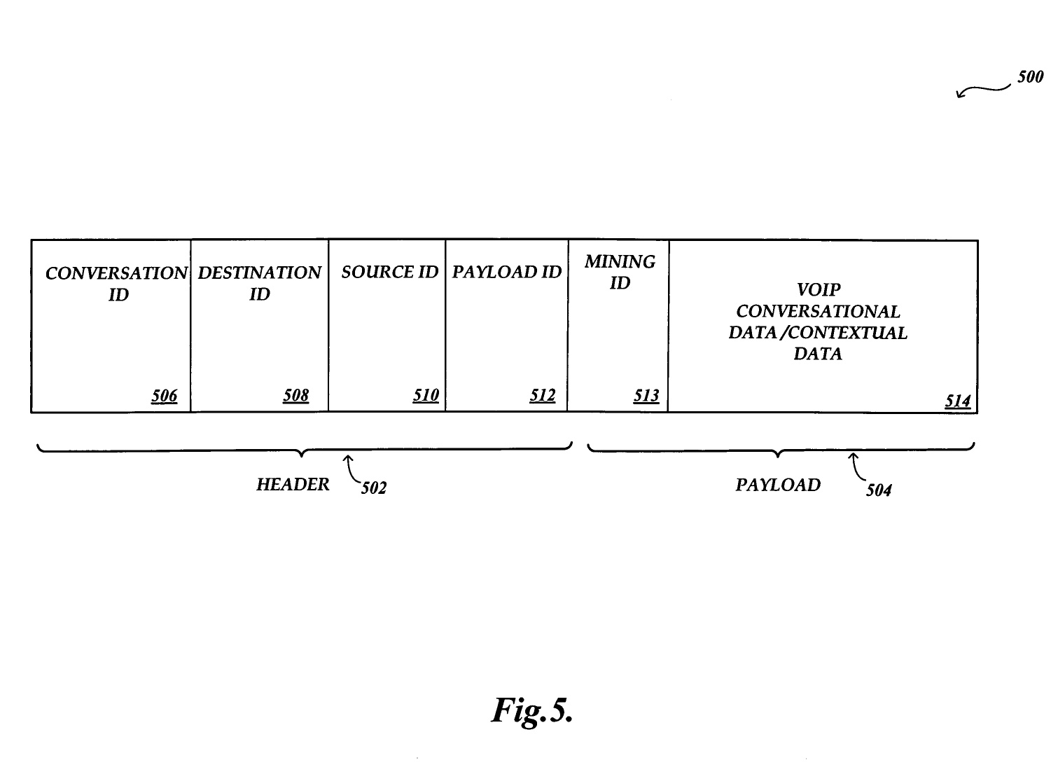

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying type of payload (e.g., conversation or contextual), a mining ID 513 for identifying that the payload may contain content worth mining, individual ID (not shown) for identifying the individual for which the conversation data is related, and the like. In an alternative embodiment, the header 502 may contain information regarding Internet protocol versions and payload length, among others. The payload 504 may include conversational or contextual data relating to an identified conversation. As will be appreciated by one of ordinary skill in the art, additional headers may be used for upper layer headers, such as a TCP header, a UDP header, and the like.

In one embodiment of the present invention, a structured hierarchy may be predefined for communicating contextual information over a VoIP conversation channel. The contextual information may include any information relating to VoIP clients, VoIP client devices, conversation channel connections (e.g., call basics), conversation context (e.g., call context), and the like. More specifically, the contextual information may include individual client mining profiles or mining profile identifiers, client rules, client's location (e.g., user location, device location, etc), biometrics information, the client's confidential information, VoIP client device functionality, VoIP service providers information, media type, media parameters, calling number priority, keywords, information relating to application files, and the like. The contextual information may be processed and collected at each VoIP client and/or the VoIP service providers depending on the nature of the contextual data.

In one aspect, the VoIP service providers may add, modify, and/or delete a VoIP client's contextual data before forwarding the contextual information. For example, a client's confidential information may be deleted by the VoIP service provider associated with that client unless the client authorizes such information to be transmitted. In some cases, a minimal amount of contextual information is transmitted outside of an intranet network. Additionally, as discussed below, some intranet networks, such as an office, may implement mining profile rules indicating what may be mined from a conversation and what may be included in a conversation for potential mining.

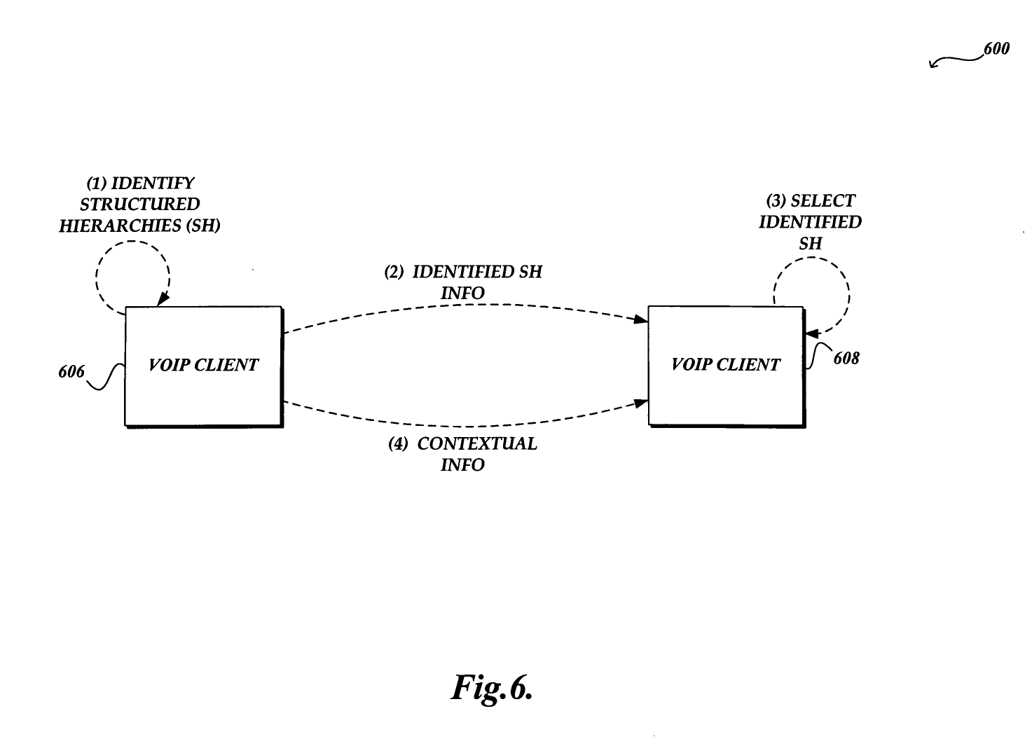

With reference to FIG. 6, a block diagram 600 illustrating interactions between two VoIP clients for transferring contextual information in accordance with an embodiment of the present invention is shown. As with FIGS. 4A and 4B, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchies, and the like. Such information will be exchanged between VoIP Client 606 and VoIP Client 608 before the corresponding contextual information is exchanged. Upon receipt of the information about which structured hierarchies are used to carry the contextual information, VoIP Client 608 looks up predefined structured hierarchies (e.g., XML namespace, and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing predefined structured hierarchies, data packets can be transmitted in a manner which is independent of hardware and/or software. Additionally, the use of predefined structured hierarchies enhances the ability to efficiently mine data because the location of potentially relevant information is known.

Upon retrieving the identified structured hierarchies, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

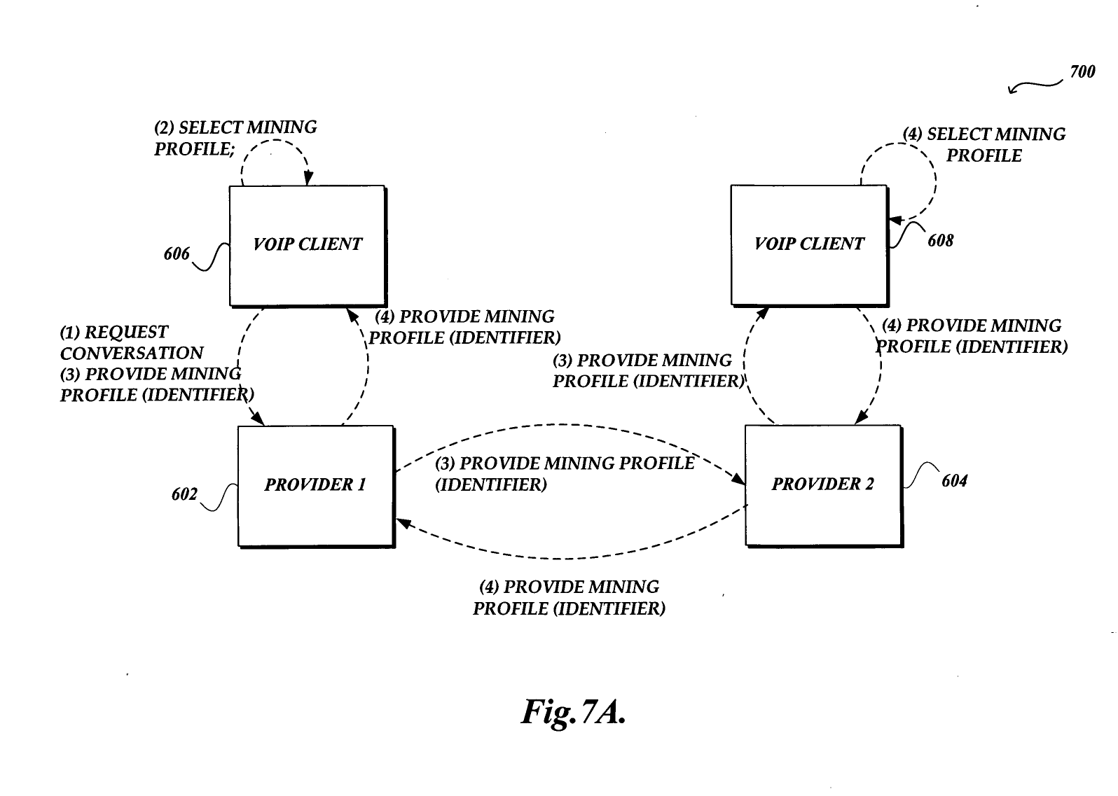

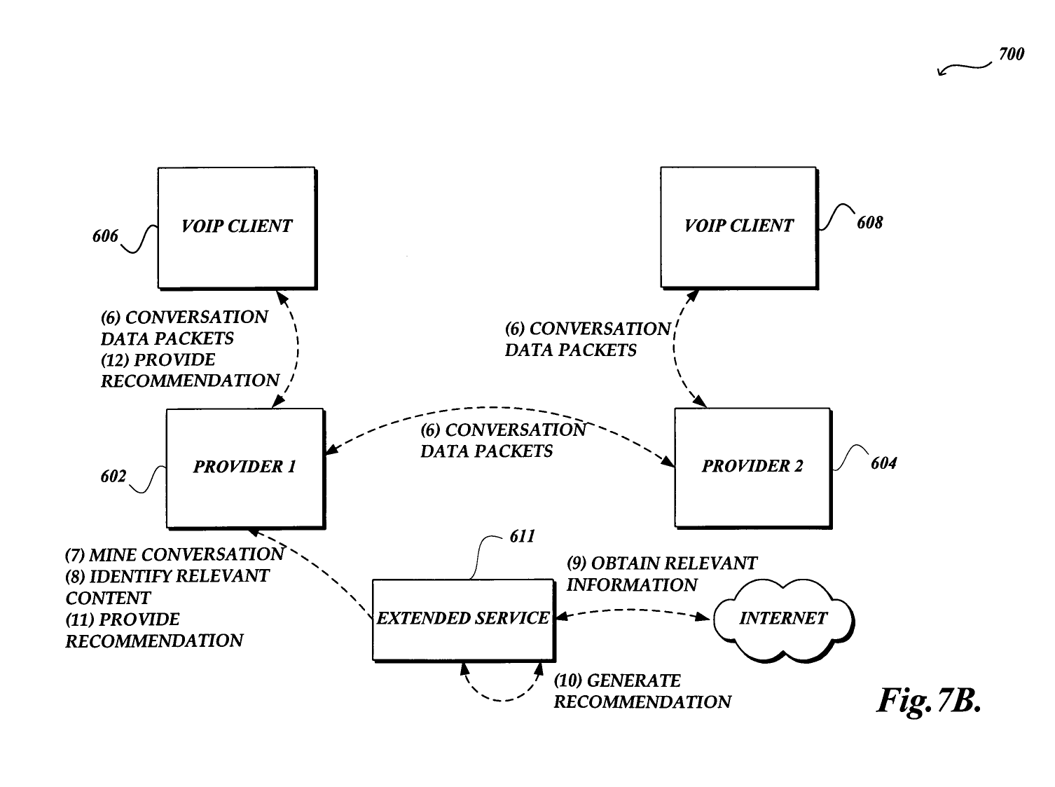

Referring to FIG. 7A, a block diagram 700 illustrates interactions between two VoIP clients for establishing a conversation channel and selecting mining profiles for use in mining data from the conversation in accordance with an embodiment of the present invention. In one embodiment, VoIP Client 606 upon requesting a connection with VoIP client 608 may select a mining profile that is to be used during the conversation. For example, if VoIP client 608 is a personal friend, VoIP client 606 may select a mining profile that has been created to mine data relating to common items of interested between the two friends. As part of the connection request and conversation channel setup, the VoIP client 606, via Provider 1 602 and Provider 2 604, may provide the selected mining profile to VoIP client 608. Alternatively, if the clients have previously exchanged mining profiles, the VoIP client 606 may simply identify the selected mining profile by sending a mining profile identifier. In a similar manner, VoIP client 608, during call establishment or at any time during the call, may provide a mining profile (or identifier thereof) of a mining profile selected by VoIP client 608 for mining of data during the conversation to Providers 602, 604 and VoIP client 606.

As discussed below, mining profiles may be exchanged because one or both of the parties may desire to perform further post-processing of data after a conversation has completed. Parties may have limitations as to the types and extent of post-processing that may be performed. These limitations may be contained in an exchanged mining profile and applied to the data packets that are stored for post-processing. In an alternative embodiment, the mining profiles may be maintained and exchanged between Provider 1 602 and Provider 2 604 and that data may be mined and/or stored for later post-processing by the Providers 602, 604. Still further, if no post-processing is to be performed, the mining profiles may not be exchanged. Mining profiles may be selected, used, and exchanged at any point in a conversation. Additionally, mining profiles may be changed, replaced, or removed during a conversation. In one embodiment, approval by the individuals participating in the conversation may be required prior to changing or replacing mining profiles during the conversation.

Referring to FIG. 7B, upon establishment of a conversation channel, during a conversation the VoIP clients 606, 608, and/or Providers 602, 604 may mine the exchanged conversation and contextual data packets for content relevant to the mining profiles. In addition, a third party, such as an “extended service” 611 may mine the conversation for relevant content and provide additional information to the clients based on that mined data. An “extended service,” as used herein, is any service that provides additional information based on mined data. While the example illustrated in FIG. 7B utilizes a third party service, an extended service or recommendation service may be provided by one or more of the providers, such as Provider 1 602 and/or Provider 2 604 and/or by one of the client devices.

In one example, the extended service may be a service with which one or more of the clients has established a relationship and developed a mining profile for mining of the conversation and the providing of additional, related information. Alternatively, the extended service may be an independent party that mines conversations and provides additional services, such as recommendations, or advertisements, based on the content of the mined data.

Continuing with FIG. 7B, when the extended service identifies and mines data containing relevant content, it seeks out and identifies information relevant to the content. For example, if a mining profile maintained by the extended service for one of the clients specifies that conversations referring to “golf” are to be mined, an individual using VoIP client 608 mentions that they want play golf this Sunday at 1:00 p.m. at Pebble Beach and are inviting the individual using VoIP client 606 to join them, data packets from that digital voice conversation may be mined by the extended service 611, processed, and additional information/recommendations may be provided to the clients. In an alternative embodiment, a system or application may show that an individual associated with VoIP client 608 is going to play golf and as a result data packets from a conversation involving that individual may be mined, processed and additional information/recommendations may be provided. For example, the extended service may obtain weather information for Pebble Beach, Calif. at 1:00 p.m., contact Pebble Beach to determine if a tee time around 1:00 p.m. on Sunday is available, and provide the collected information to one or more of the VoIP clients during the conversation. Additionally, if a tee time is available, the extended service may temporarily hold the tee time and present the clients with an option for reserving the tee time, selecting a different tee time, etc. Assuming the clients accept the tee time, the extended services may confirm the reservation with Pebble Beach, provide the necessary credit card information (assuming it has been previously obtained from a client), and generate a calendar event for Sunday at 1:00 p.m. for golf at Pebble Beach and present the event to the clients, thereby allowing the clients to easily schedule the event on their calendars. Information may be presented to clients via the same VoIP device on which they are communicating and/or via a different device or application.

Additionally, the extended service may identify advertisements for golf related products and services and, depending on the conditions (e.g., weather) expected for the event, provide recommendations to the clients, either during or after the call. For example, if the extended service determines that it will likely rain at Pebble Beach during the scheduled round of golf, it may identify sales for rain gear and recommend appropriate rain gear for purchase, rent, or reservation (and provide the location of the store and other details). Likewise, the golf course may provide information or advertisements to the clients. For example, it may provide the estimated time for completing the round, identification of demonstration clubs available for use, food, or beverage pre-ordering options, or other services that the golf course may provide (e.g., card detailing).

Multiple mining profiles may be applied to a conversation and the data packets may be mined and processed real-time with results of the processing being provided to the client(s) during the conversation. Rules may also be placed on the mining profiles, thereby modifying the amount and/or types of data that may be mined. Still further, data packets may be mined and processed at a later point in time (post-processing).

In addition to exchanging mining profiles, as discussed above, structured hierarchies may be specified for use during the conversation that assist in efficient mining of data packets by specifying the structure of the data that is transmitted. A VoIP Client 606 may also define additional classes and/or attributes to the set of predefined structured hierarchies. For example, VoIP Client 606 may identify structured hierarchies with additional attributes and classes for particular contextual information. VoIP Client 606 transmits information corresponding to the identified hierarchies and its additional attributes and classes to Provider 1 602. Provider 1 602 forwards the information corresponding to the identified structured hierarchies and its additional attributes and classes to Provider 2 604. VoIP Client 608 receives the information regarding the identified structured hierarchies and its additional attributes and classes from Provider 2 604. Alternatively, Provider 1 602 forwards such information to VoIP Client 608. VoIP Client 608 updates the locally stored structured hierarchies based on the additional attribute and class information. As a result, the identified structured hierarchies are expanded at VoIP Client 606 and VoIP Client 608. VoIP Client 606 starts sending contextual information represented according to the expanded structured hierarchies to Provider 1 602, which in return sends the received contextual information to Provider 2 604. In one embodiment, upon receipt of the contextual information from Provider 2 604, VoIP Client 608 processes the received contextual information by constructing an instance of the expanded structured hierarchies of the received contextual information.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software and hardware independent tool for transmitting information. Further, XML maintains its data as a hierarchically-structured tree of nodes, each node comprising a tag that may contain descriptive attributes. Typically, a XML namespace is provided to give the namespace a unique name. In some instances, the namespace may be used as a pointer to a centralized location containing default information about the namespace.

In a particular embodiment, VoIP Client 606 identifies a XML namespace for contextual information by placing the XML namespace attribute in the start tag of a sending element. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information. As will be appreciated, any technique for identifying the structured hierarchies may be used with embodiments of the present invention. The example of identifying an XML namespace through a start tag is provided as an example only and is not to be considered as limiting.

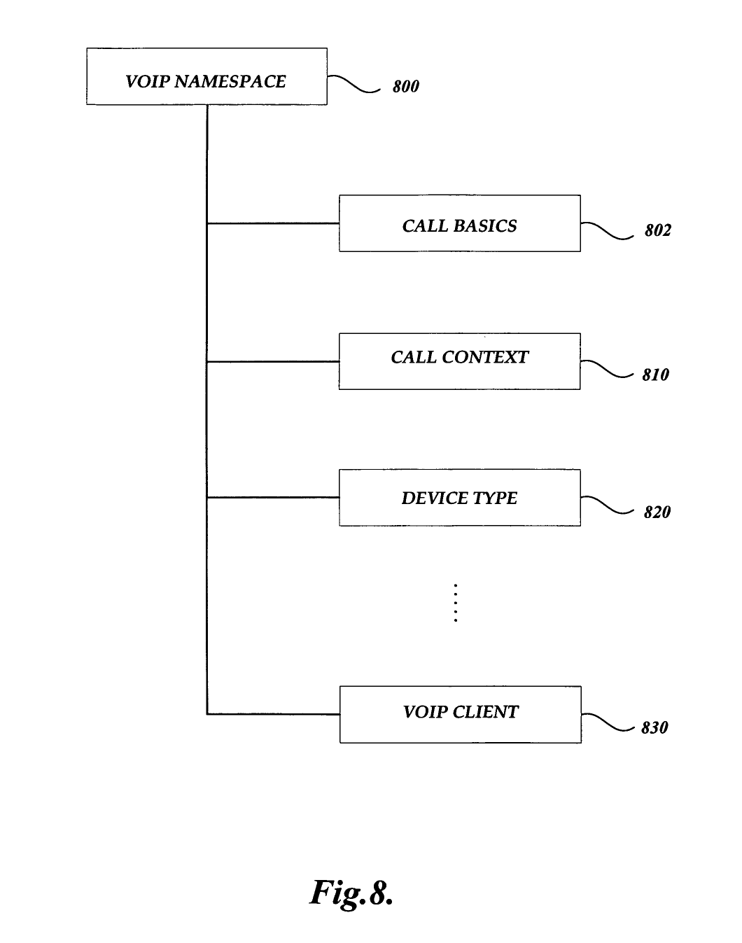

With reference to FIGS. 8-12, block diagrams illustrative of various classes and attributes of structured hierarchies corresponding to VoIP contextual information are shown. As mentioned above, structured hierarchies are predefined organizational structures for arranging contextual information to be exchanged between two or more VoIP devices. Structured hierarchies can be defined, updated, and/or modified by redefining various classes and attributes. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830, and the like.

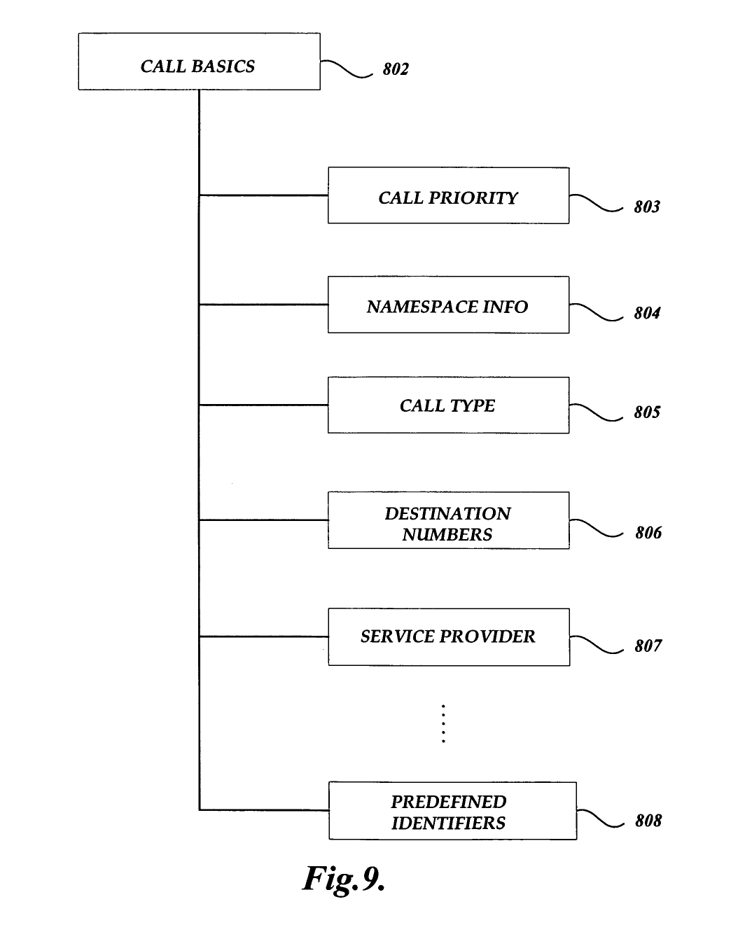

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include an originating address (e.g., a caller's VoIP ID number), destination numbers (e.g., callees'VoIP ID numbers or telephone numbers), call connection time, VoIP service provider related information, and/or ISP related information, such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah,” “oops,” “wow,” etc.) and facial expressions in graphical symbols. In one embodiment, a Call Basics Class 802 may be defined as a sub-tree structure of a VoIP Namespace 800, which includes nodes, such as call priority 803, namespace information 804, call type 805, destination numbers 806, service provider 807, predefined identifiers 808, and the like.

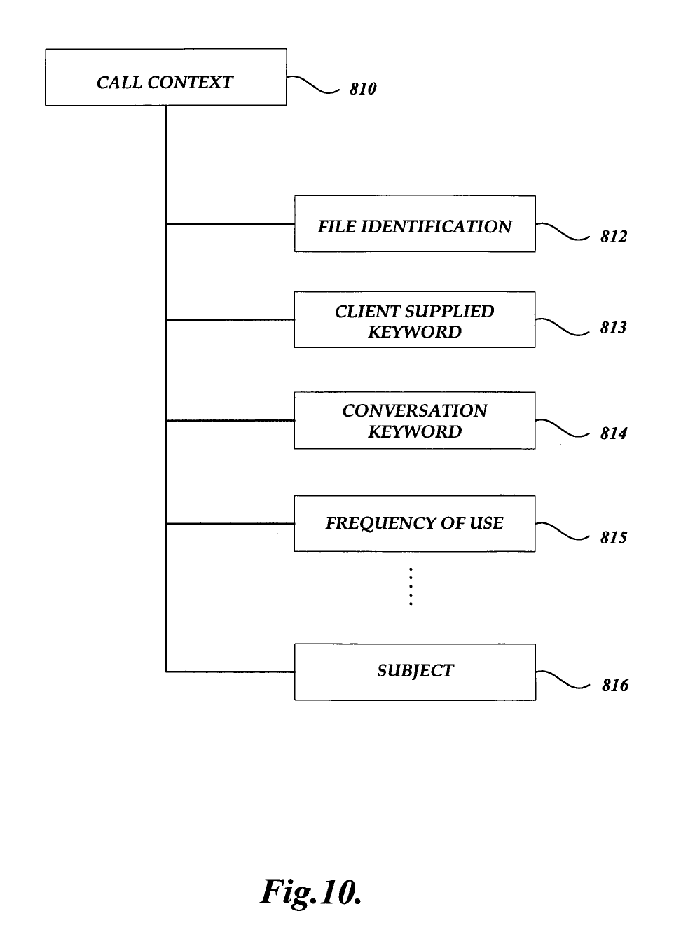

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information, such as client supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

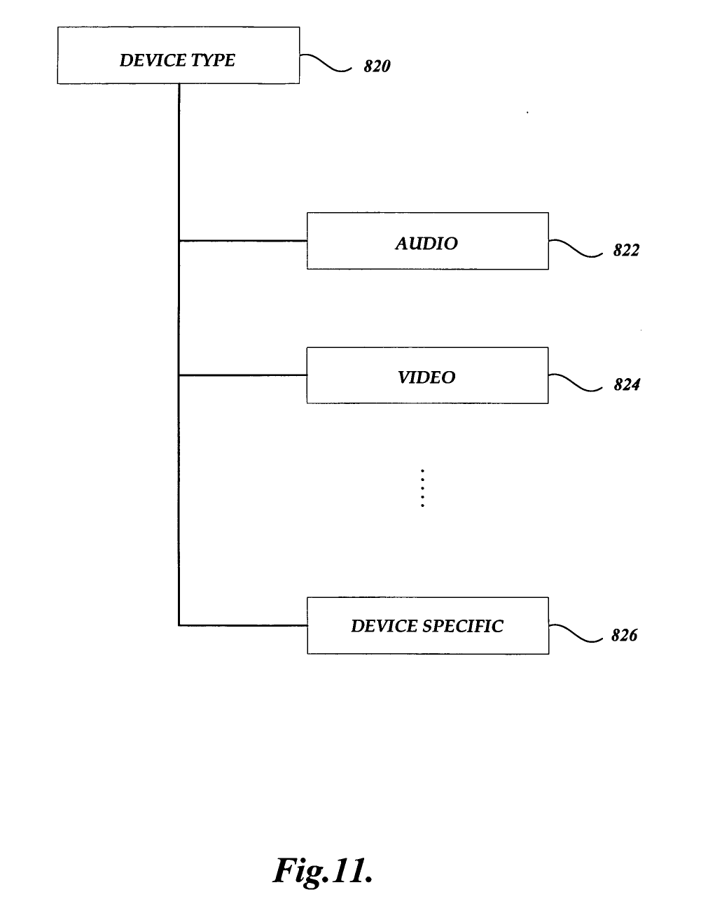

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type, and size of the video data, graphic card information, and the like. Additionally, if system incompatibilities are determined, a translation layer may be added to reconfigure the information being exchanged to enable communication between different types of systems. The contextual information relating to VoIP client devices may further include other device specific information, such as a type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826, and the like.

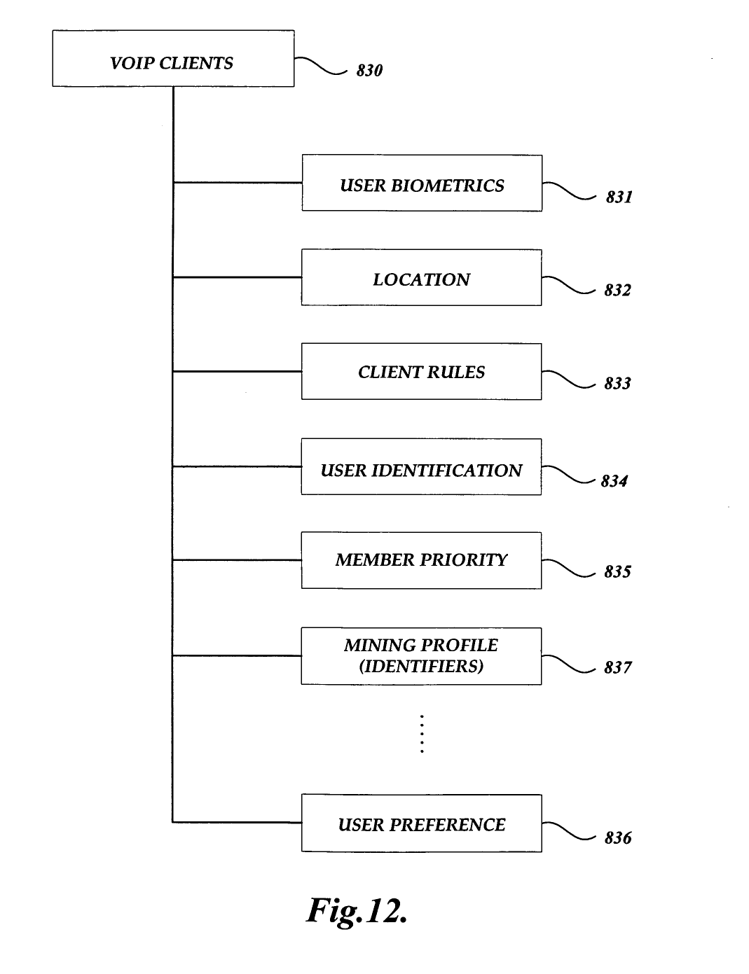

With reference to FIG. 12, a block diagram of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, biometric information, and mining profile information (e.g., identifying a primary profile or set of mining profiles that are to be used in mining the conversations). A mining profile may include information as to the types of content that is to be mined (mining requirements), how data packets are to be mined (e.g., voice recognition, keyword search, etc.), when the data packets are to be mined (real-time or stored and mined later), the processing that is to be done with mined data packets (e.g., updating a journal, generating tasks, retrieving related information, generating advertisements, etc.), when processing is to be done (real-time or later) and the types of content that is allowed to be mined from the conversation.

The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a sub-tree structure of a VoIP Namespace 800, which includes nodes corresponding to user biometrics 831, location 832, client rules 833, user identification 834, member priority 835, user preference 836, mining profile identification 837, and the like.

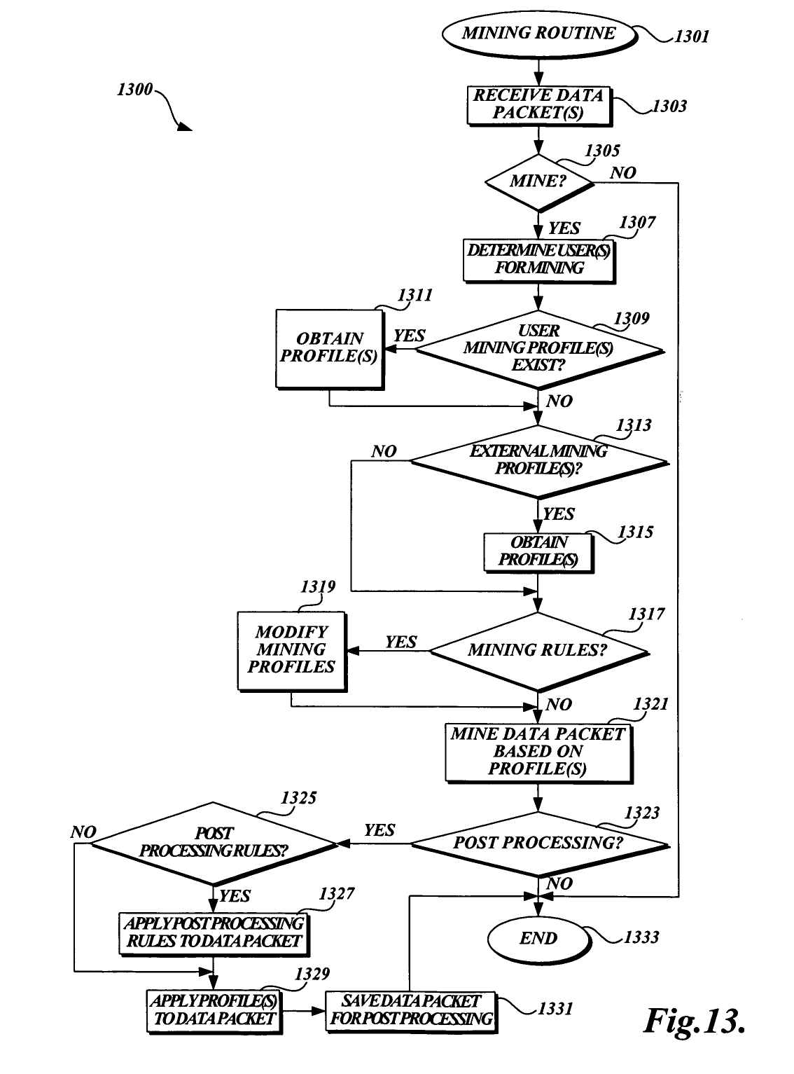

FIG. 13 is a flow diagram of a mining routine for mining data packets from a digital voice conversation in accordance with an embodiment of the present invention. The mining routine 1300 begins at block 1301. At block 1303, a data packet from a voice conversation is received. As will be appreciated, the mining routine 1300 may be performed using a single data packet or utilizing a group of data packets. At decision block 1305, a determination is made as to whether that data packet is to be mined. As discussed above, a data packet may include a mining identifier 513 (FIG. 5) in the header of the data packet identifying that the payload of the data packet may include content worth mining. Alternatively, any technique for identifying data packets that may include content worth mining may be utilized with embodiments of the present invention. For example, if the data packet is of a particular size, thereby indicating that it may contain useful content worth mining, the data packet may be selected for mining at decision block 1305. In yet another embodiment, it may be determined whether to mine the data packets before they are received. For example, it may be determined that all data packets are to be mined.

If it is determined at decision block 1305 that the received data packet is to be mined, at block 1307, client profiles for mining are selected. As discussed above, a client may create one or more profiles for use in a digital voice conversation that identify the types of content that is to be mined. For example, a client may create a personal mining profile that is used in personal conversations. Such a personal mining profile may include topics or categories identifying the types of content that is to be mined from the conversation itself. For example, if a client is interested in shoes, the personal mining profile may include an identifier to search for keywords or utilize speech recognition to identify conversations that include references to shoes or types of shoes. Additionally, contextual information of a conversation may be searched according to the structured hierarchies discussed above and the relevant portions of the contextual information utilized to determine if the content or the structure of the data packet includes references to shoes.

At decision block 1309, a determination is made as to whether one or more client mining profiles that are to be used to mine the data packet received at block 1303 exist. If it is determined at block 1309 that one or more client mining profiles do exist, at block 1311, those profiles are obtained. At decision block 1313, either after the one or more profiles are obtained at block 1311, or if it is determined at decision block 1309 that no profiles exist, it is determined whether external mining profiles that are to be used to mine the data packet received at block 1303 exist. External profiles may be, for example, but not limited to, profiles generated by clients or others that are to be used in mining the conversation. For example, a client may request a third party to mine conversations for that individual for particular content of interest. Additionally, external mining profiles may include, but are not limited to, security profiles managed by service providers, the government, companies, etc.

If it is determined at decision block 1313 that external mining profiles are to be used in mining the received data packet, at block 1315, those profiles are obtained. Upon obtaining the external mining profiles at block 1315, or if it is determined at decision block 1313 that there are no external mining profiles, at decision block 1317, it is determined whether there are any mining rules that are to be applied to the mining. Mining rules may be, for example, rules specified by a company from which a call is being generated. For example, if a client is making a call from a company, the company may have mining rules that do not allow any mining of conversations originating from that company or including conversations within that company. Alternatively, the mining rules may specify when calls may be made from a particular location, such as a company. If it is determined at decision block 1317 that mining rules exist, at block 1319, the mining profiles obtained at block 1311 and block 1315 are modified, based on those mining rules.

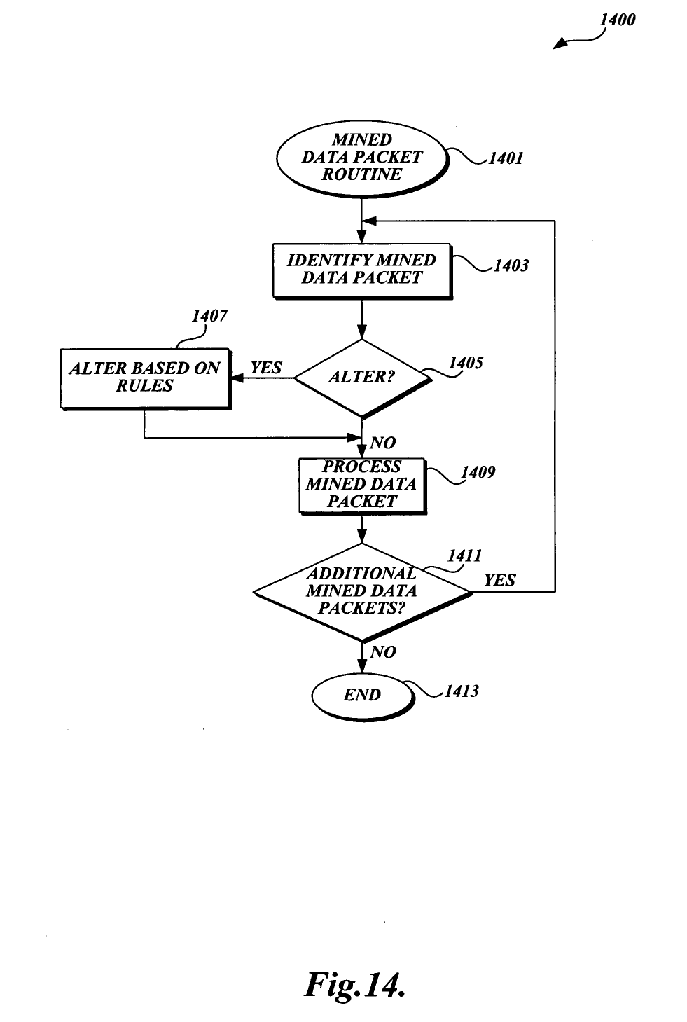

At block 1321, after the obtained mining profiles are modified at block 1319, or if it is determined at decision block 1317 that there are no mining rules, the data packets received at block 1303 is mined based on the obtained profiles. For example, if the mining profile specifies that a data packet (or a group of data packets) is to be mined using voice recognition and searching for keywords, and if content is identified that includes the relevant keywords, it may be marked or otherwise identified as a “mined data packet” that is to be further processed. Processing of mined data packets is described in further detail with respect to FIG. 14.

In addition to mining data packets during a conversation, it may be determined at decision block 1323 as to whether any post-processing of the conversation or mined data packet is to be performed. If it is determined at decision block 1323 that post-processing is to be performed, at decision block 1325, it is determined whether there are any post-processing rules. If it is determined at decision block 1325 that there are post-processing rules, at block 1327 those post-processing rules are applied to the mined data packet. Post-processing rules may be, for example, rules as to what type of post-processing may be performed on the data packet, what may be done with the content that is mined from the data packet during post-processing, etc. However, if it is determined at decision block 1325 that there are no post-processing rules, or after post-processing rules are applied at block 1327, the profiles obtained at block 1311 and block 1315, which were possibly modified at block 1319, are applied and associated with the mined data packet that is to be post-processed. Data packets that are to be post-processed are associated with mining profiles and rules so that those profiles and rules can be identified and obtained when the post-processing of the data packets occurs. Alternatively, the mining profile may not be applied to the mined data packet. At block 1331 the mined data packets, post-processing rules, and optionally the applied profiles, are saved for post-processing. After the data packets and appropriate information is saved at block 1331 for post-processing, if it is determined at block 1323 that no post-processing is to be accomplished, or if it is determined at decision block 1305 that the received data packet is not to be mined, the VoIP mining routine 1300 completes, as illustrated by block 1333.

FIG. 14 is a flow diagram of a mined data packet routine for processing a data packet that has been mined from a digital voice conversation in accordance with an embodiment of the present invention. The mined data packet routine 1400 begins at block 1401. At block 1403, a data packet(s) that has been mined from a digital voice conversation is identified. Similar to FIG. 13, the mined data packet routine 1400 may be performed on a single data packet or a group of data packets. Additionally, as discussed above, mined data packets may contain conversation data or contextual data. At decision block 1405, a determination is made as to whether the mined data packet or the content of the mined data packet is to be altered. If it is determined at decision block 1405 that the mined data packet/content is to be altered, at block 1407, that mined data packet/content is altered. Mined data packets or the content may be altered based on rules applied to the mining profiles and/or based on post-processing rules. For example, a rule may specify that all mined data packets containing content relating to trade secret information of a corporation are to be removed from the conversation and forwarded to an officer of the corporation. Any type of alteration may be performed on mined data packets and/or the content of those packets including, but not limited to, removing the data packet from the conversation, replacing the content of the data packet with other content, storing the data packet for future use, recording the data packet or the content of the data packet, etc.

After the mined data packet or content has been altered at block 1407, or if it is determined at block 1405 that the data packet or content is not to be altered, at block 1409, the mined data packet is processed in any of a variety of ways. Mined data packets may be processed in a multitude of ways to provide additional services to a client. For example, content from a mined data packet may be used to feed another application or service, such as a diary, a task list, etc., that may be later accessed by a client to review the conversation or obtain additional information. Likewise, content from the mined data packet may be used to obtain other information related to the content. For example, referring again to the example of mining data packets containing content related to shoes, if the content was a conversation about Nike® shoes, a mining service provider may obtain additional information regarding Nike® shoes. For example, additional information may be sales of Nike® shoes, locations for purchasing Nike® shoes, quality of Nike® shoes, etc. This information may be stored with the conversation for later viewing by a client and/or provided to the client during the conversation.

In addition to feeding other applications, content from mined data packets may be used to redirect portions of a particular conversation. For example, if the content refers to a personal portion of conversation and is a high quality video, but the receiving device is a corporate device with no video capabilities, the video portion of that conversation may be rerouted to a different client device that provides the necessary capabilities and viewed or stored for later viewing on that device. Additionally, a network may utilize mined data packets for load balancing to reroute or reprocess conversations based upon the contents and size of those conversations as specified by the mined data packets.

As will be appreciated by one skilled in the relevant art, there is an endless number of processing techniques and varieties that may be used to process mined data packets and provide additional services to clients. Accordingly, the examples provided herein are for illustration only and not to be construed as limiting.

After the mined data packet is processed at block 1409, at decision block 1411, a determination is made as to whether additional mined data packets have been received that are to be processed. If it is determined at decision block 1411 that additional mined data packets exists for processing, the routine returns to block 1403 and continues. However, if it is determined at decision block 1411 that there are no additional mined data packets to be processed, the routine 1400 completes at block 1413.

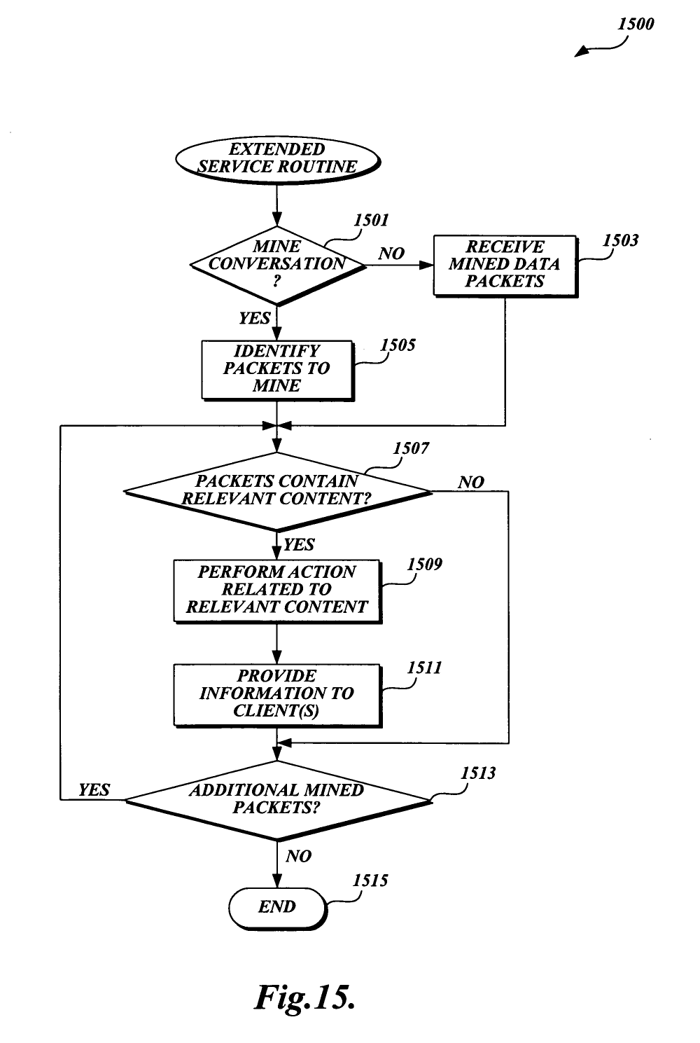

FIG. 15 is a flow diagram of an extended services routine for providing additional information (e.g., recommendations) in accordance with an embodiment of the present invention. The extended service routine 1500 begins at decision block 1501 and a determination is made as to whether a conversation for which additional information may be provided by the extended service is to be mined by the extended service. If it is determined at decision block 1501 that the extended service is not to mine the conversation, at block 1503 the extended service receives data packets that have already been mined from the conversation. As discussed above, any VoIP entity, such as a VoIP client device, service provider, etc., may mine conversations for relevant data packets. However, if it is determined at decision block 1501 that the extended service is to mine the conversation, at block 1505 data packets from the conversation worth mining are identified. As discussed above, data packets for mining may be identified by searching the header of the data packet for an identifier indicating that the data packet may contain relevant content.

Upon mining data packets at block 1505 or receiving previously mined data packets at block 1503, the routine 1500, at decision block 1507, determines if the mined data packets contain relevant content. Relevant content may be determined based on the type of service being provided by the extended service. For example, if the service being provided is a service for providing recommendations relating to particular items previously identified by the user as being of relevant interest, the mined data packets will be processed to determine if conversation data related to the category of interest is included. Upon determining that data packets contain relevant content at decision block 1507, at block 1509 the desired action related to the relevant content is performed. Continuing with the example of playing golf at Pebble Beach, if the desired action is to identify sales for golf equipment that are available at stores between the address of a client and the golf course, the extended service may identify stores having sales that match the criteria specified by the client and recommend an appropriate store to the client. In an alternative example, the relevant content may be combined with additional information obtained from the client (e.g., biometrics) and extended services may be provided based on that combination.

As illustrated in block 1511, the result of the action performed at block 1509 may be provided to the client in the form of information or a recommendation. Upon a determination at decision block 1507 that the packets do not contain relevant content or after providing information to a client at block 1511, at decision block 1513 a determination is made as to whether additional mined data packets exist. If it is determined at decision block 1513 that additional mined data packets exist, the routine returns to decision block 1507 and continues. However, if it is determined at decision block 1513 that additional mined data packets do not exist, the routine 1500 completes, as illustrated by block 1515.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for providing extended services to a client, comprising:
obtaining one or more mined digital conversation data packets;
determining if the obtained one or more digital conversation data packets contain relevant content; and
if it is determined that the obtained one or more digital conversation data packets contain relevant content, providing to the client information related to the content.

2. The method of claim 1, wherein obtaining one or more data packets includes:
mining a digital conversation to identify data packets that may contain relevant content.

3. The method of claim 1, wherein obtaining one or more data packets includes:
obtaining data packets that have been previously mined from a digital conversation.

4. The method of claim 1, wherein providing information related to the content includes:
providing a recommendation to the client that is related to the relevant data.

5. The method of claim 1, further comprising:
receiving input from the client related to the provided information.

6. The method of claim 5, wherein the input is an acceptance of an event that is provided to the client.

7. The method of claim 1, wherein providing information related to the content includes:
providing information related to the content to a plurality of clients.

8. The method of claim 1, further comprising:
identifying information related to the relevant content; and
wherein providing information related to the content includes providing the identified information.

9. The method of claim 8, wherein the identified information is located on a third party service provider.

10. The method of claim 1, further comprising:
taking action on behalf of the client, wherein the action is related to the information that is provided.

11. The method of claim 1, wherein the extended services are provided by a client device.

12. The method of claim 1, wherein the extended services are provided by a service provider.

13. The method of claim 1, wherein the extended services are provided by a third party.

14. A computer-readable medium having computer executable components for providing extended services to a client, comprising:
a monitoring component for monitoring and identifying data packets of a digital voice conversation that contain relevant content; and
a processing component configured to obtain additional information related to the content and for providing the obtained additional information to a client.

15. The computer-readable medium of claim 14, wherein the processing component is further configured to receive a response from the client.

16. The computer-readable medium of claim 14, wherein the additional information is advertising information.

17. The computer-readable medium of claim 14, wherein the additional information is advertising information that is identified based on the relevant content.

18. A method for specifying information that is to be used for providing recommendation services, comprising:
maintaining for a client a mining profile, wherein the mining profile specifies content that is to be identified from a conversation and actions that are to be performed when content is identified; and
maintaining a list of clients for which a conversation may be mined based on the mining profile.

19. The method of claim 18, wherein the action includes providing a recommendation to the client.

20. The method of claim 18, wherein maintaining for a client a mining profile includes maintaining a plurality of mining profiles for the client; and wherein the profiles are used for digital voice conversations with different clients.
